(19) United States
(12) Patent Application Publication
(10) Pub. No.: US 2020/0216350 A1
(43) Pub. Date: Jul. 9, 2020

(54) APPARATUS AND METHOD FOR MANUFACTURING GLASS SUBSTRATE

(71) Applicant: LG CHEM, LTD., Seoul (KR)

(72) Inventors: Chang Song LEE, Daejeon (KR); Kyu Hwang LEE, Daejeon (KR); Kyu Jong LEE, Daejeon (KR)

(21) Appl. No.: 16/649,054

(22) PCT Filed: Sep. 20, 2018
(86) PCT No.: PCT/KR2018/011091

§ 371 Date: Mar. 19, 2020

(30) Foreign Application Priority Data
Sep. 20, 2017 (KR) 10-2017-0120911

(51) Int. Cl. C03B 35/16; C03B 25/08

(52) U.S. Cl. CPC C03B 35/164; C03B 25/08

(57) ABSTRACT

Provided is a method for manufacturing a glass substrate, comprising steps of: cooling a glass substrate transported by a plurality of rollers rotating at a predetermined speed; predicting a crack defect rate of the glass substrate in accordance with a plurality of predictive factors related to crack defects of the glass substrate and rotational speed information of the respective rollers, in the transport process; and adjusting the rotational speed of each roller so that the crack defect rate of the glass substrate is lowered. Also provided is an apparatus for manufacturing a glass substrate, comprising a transport part for cooling a glass substrate transported by a plurality of rollers rotating at a predetermined speed, a prediction part for predicting a crack defect rate of the glass substrate through a partial least squares regression analysis, and a control part for controlling the rotation speed of each roller.

### TECHNICAL FIELD

The present invention relates to a method and an apparatus for manufacturing a glass substrate, and more particularly, to a method and apparatus for manufacturing a glass substrate for minimizing crack defects in the glass substrate upon performing a slow cooling process of the glass substrate during a glass manufacturing process.

This application claims the benefit of priority based on Korean Patent Application No. 10-2017-0120911 filed on Sep. 20, 2017, the disclosure of which is incorporated herein by reference in its entirety.

### BACKGROUND ART

FIGS. 1 and 2 are schematic diagrams showing an apparatus for manufacturing a glass substrate.

Referring to FIGS. 1 and 2, an apparatus for manufacturing a glass substrate is used in a manufacturing process of a glass substrate for manufacturing a thin plate glass of about 0.5 mm, and the manufactured glass substrate is used as a material for an optical panel such as a TV and a notebook computer, so that it is very important to control the optical characteristics, physical strength, and the like in the process.

In the glass substrate manufacturing process, a quality issue is a crack defect in the glass substrate. Cracks in the substrate cause glass breakage and optical property deterioration.

### DISCLOSURE

### Technical Problem

It is a problem to be solved by the present invention to provide a method and an apparatus for manufacturing a glass substrate capable of deriving causal factors of occurrence of crack defects, and predicting and reducing a crack defect rate, by utilizing data measured in a glass substrate manufacturing process.

### Technical Solution

To solve the above-described problem, according to one aspect of the present invention, there is provided a method for manufacturing a glass substrate, comprising steps of: cooling a glass substrate transported by a plurality of rollers rotating at a predetermined speed; predicting a crack defect rate of the glass substrate in accordance with a plurality of predictive factors related to crack defects of the glass substrate and rotational speed information of the respective rollers, in the transport process, and adjusting the rotational speed of each roller so that the crack defect rate of the glass substrate is lowered.

In addition, according to another aspect of the present invention, there is provided an apparatus for manufacturing a glass substrate, comprising a transport part for cooling a glass substrate transported by a plurality of rollers rotating at a predetermined speed, a prediction part for predicting a crack defect rate of the glass substrate through a partial least squares regression analysis of a plurality of predictive factors related to crack defects of the glass substrate and rotational speed information of the respective rollers, in the transport process, and a control part for controlling the rotation speed of each roller so that the crack defect rate of the glass substrate is lowered.

### Advantageous Effects

As described above, the method and apparatus for manufacturing a glass substrate according to one example of the present invention have the following effects.

Using the data measured in the glass substrate manufacturing process, it is possible to develop a model capable of deriving causal factors of occurrence of crack defects and predicting a crack defect rate.

Also, based on this model, the rotational speed of each roller of a dross box can be adjusted to reduce the crack defect rate.

### BRIEF DESCRIPTION OF DRAWINGS

FIGS. 1 and 2 are schematic diagrams showing an apparatus for manufacturing a glass substrate.

FIG. 3 is a configuration diagram showing predictive factors for modeling crack defect rates.

FIG. 4 is a graph showing crack defect rates predicted through a crack defect rate prediction model and actually measured crack defect rates.

FIG. 5 is graphs showing the relationship between the rotational speed offset of each roll and the crack defect rate.

### MODE FOR INVENTION

Hereinafter, a method and an apparatus for manufacturing a glass substrate according to one example of the present invention will be described in detail with reference to the accompanying drawings.

In addition, the same or similar reference numerals are given to the same or corresponding components regardless of reference numerals, of which redundant explanations will be omitted, and for convenience of explanation, the size and shape of each constituent member as shown can be exaggerated or reduced.

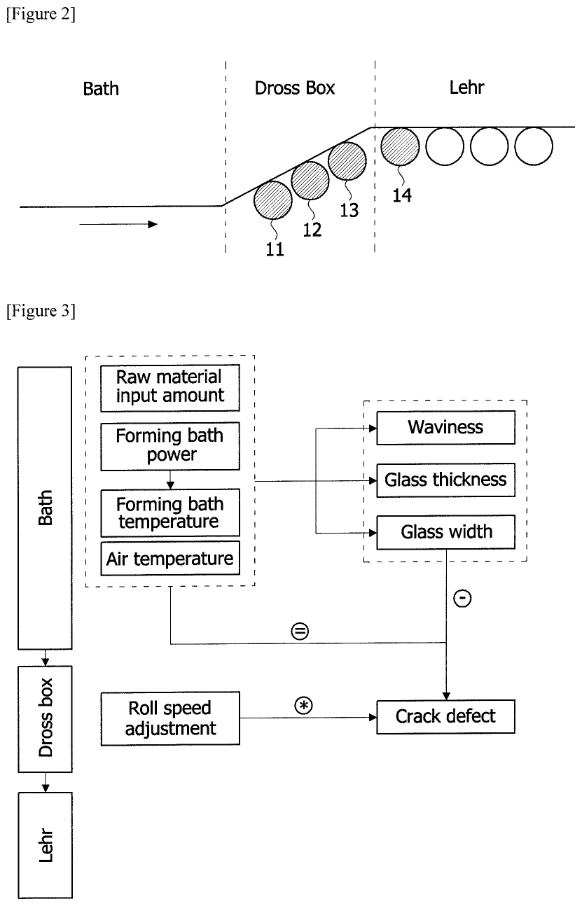

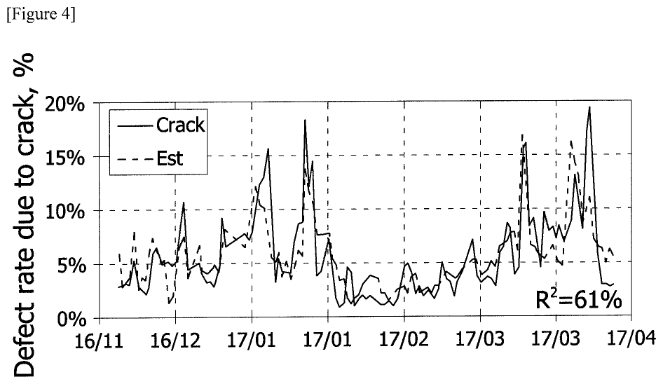

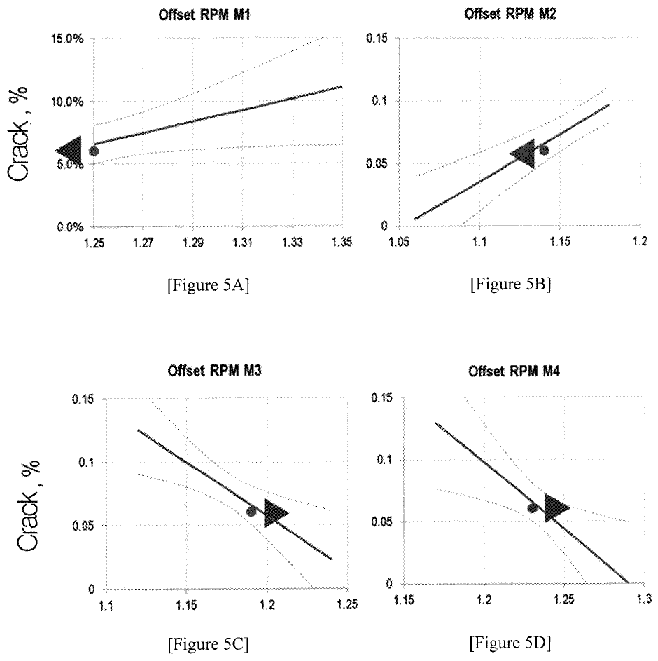

FIG. 3 is a configuration diagram showing predictive factors for modeling crack defect rates, FIG. 4 is a graph showing crack defect rates predicted through a crack defect rate prediction model and actually measured crack defect rates, and FIG. 5 is graphs showing the relationship between the rotational speed offset of each roller and the crack defect rate.

An apparatus for manufacturing a glass substrate related to one example of the present invention comprises a transport part for cooling a glass substrate transported by a plurality of rollers rotating at a predetermined speed, a prediction part for predicting a crack defect rate of the glass substrate through a partial least squares regression analysis of a plurality of predictive factors related to crack defects of the glass substrate and rotational speed information of the respective rollers, in the transport process, and a control part for controlling the rotation speed of each roller so that the crack defect rate of the glass substrate is lowered.

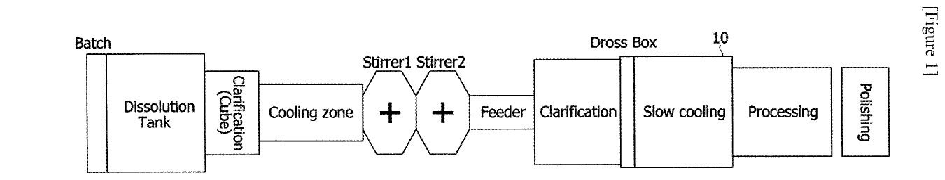

Referring to FIG. 1, the glass substrate manufacturing apparatus comprises a slow cooling device (10). Referring to FIG. 2 and explaining the glass forming and slow cooling device (10), it comprises a bath, a dross box and a lehr. At this time, the transport part comprises a plurality of rollers (11, 12, 13, 14), and the plurality of rollers are located on the dross box side, in particular. The plurality of rollers transport the glass substrate, and in the transport process, the cooling (slow cooling) of the glass substrate is performed.

On the other hand, during slow cooling, cracks can occur in the glass substrate. In particular, the rotational speed of each of the rollers (11, 12, 13, 14) must be optimized in accordance with the transport speed of the glass substrate. If the transport speed of the glass substrate and the rotational speed of the rollers are not optimized, a crack is generated in the glass substrate due to friction between the glass substrate and the rollers (11, 12, 13, 14). That is, the rotational speed of the rollers must be adjusted so that any offset does not occur therein so as to be optimized to the transport speed of the glass substrate.

A method for manufacturing a glass substrate related to one example of the present invention comprises steps of: cooling a glass substrate transported by a plurality of rollers rotating at a predetermined speed (hereinafter, cooling step); predicting a crack defect rate of the glass substrate in accordance with a plurality of predictive factors related to crack defects of the glass substrate and rotational speed information of the respective rollers, in the transport process (hereinafter, prediction step), and adjusting the rotational speed of each roller so that the crack defect rate of the glass substrate is lowered (hereinafter, adjustment step).

Referring to FIG. 3, the plurality of predictive factors include operating conditions of the glass forming process and the width of the glass, and statistical modeling by multivariate technique is possible with predictive factors and rotational speed information of each roller. The plurality of predictive factors can include a raw material input amount, a glass thickness, a forming bath power, a forming bath temperature and an outside air temperature. However, a number of predictive factors (operating conditions, glass width, etc.) are conditions that are difficult to change in order to reduce the crack defect rate. However, it is possible to predict and reduce the crack defect rate through optimization of the respective rollers (11, 12, 13, 14). Therefore, the predictive factors can be reference factors, and the rotational speed information of each roller can correspond to an optimization factor.

At this time, the prediction step can be performed by estimating a crack defect rate through a partial least squares regression analysis of a plurality of predictive factors and rotational speed information of a plurality of rollers.

Referring to FIG. 4, it is possible to develop a predictive model that can account for about 61% through the partial least squares regression analysis based on the plurality of predictive factors.

Also, the rotational speed information of the rollers (11, 12, 13, 14) can be an offset of the rotational speed of each of the rollers for the transport speed of the glass substrate. Therefore, the rotational speed of each roller can be adjusted so as to reduce the offset.

Furthermore, the prediction step and the adjustment step can be performed in real time.

Referring to FIG. 5, roller rotation speeds and optimum directions of four rollers (11, 12, 13, 14) at a specific operation time can be presented through the analysis model. In FIG. 5, M1 denotes the roller of Reference No. 11, M2 denotes the roller of Reference No. 12, M3 denotes the roller of Reference No. 13, and M4 denotes the roller of Reference No. 14.

In addition, the blue solid line represents the sensitivity function of the roller speed at a specific operation time, and the blue dotted lines represent the confidence interval. Furthermore, the red dot is the roller rotation speed at the relevant time, and shows which direction (roller speed increase/decrease) should be adjusted to minimize the crack defect rate.

For example, referring to (a) and (b) in FIG. 5, they correspond to the case where the speed of the roller is faster than the transport speed of the glass substrate, so that the rotational speed of the relevant roller must be reduced. Alternatively, referring to (c) and (d) in FIG. 5, they correspond to the case where the speed of the roller is slower than the transport speed of the glass substrate, so that the rotational speed of the relevant roller must be increased.

The preferred examples of the present invention as described above are disclosed for illustrative purposes, which can be modified, changed and added within thought and scope of the present invention by those skilled in the art and it will be considered that such modification, change and addition fall within the following claims.

### INDUSTRIAL APPLICABILITY

According to the method and apparatus for manufacturing a glass substrate related to one example of the present invention, using the data measured in the glass substrate manufacturing process, it is possible to develop a model capable of deriving causal factors of occurrence of crack defects and predicting a crack defect rate.

1. A method for manufacturing a glass substrate, comprising steps of:
cooling a glass substrate transported by a plurality of rollers rotating at a predetermined speed;
predicting a crack defect rate of the glass substrate in accordance with a plurality of predictive factors related to crack defects of the glass substrate and rotational speed information of the respective rollers, in the transport process; and
adjusting the rotational speed of each roller so that the crack defect rate of the glass substrate is lowered.

2. The method for manufacturing a glass substrate according to claim 1, wherein the plurality of predictive factors include operating conditions of the glass forming process and the width of the glass.

3. The method for manufacturing a glass substrate according to claim 2, wherein the plurality of prediction factors include a raw material input amount, a glass thickness, a forming bath power, a forming bath temperature and an outside air temperature.

4. The method for manufacturing a glass substrate according to claim 2, wherein the prediction step is performed by estimating a crack defect rate through a partial least squares regression analysis of a plurality of predictive factors and rotational speed information of a plurality of rollers.

5. The method for manufacturing a glass substrate according to claim 1, wherein the rotational speed information of the rollers is an offset of a rotational speed of each of the rollers for the transport speed of the glass substrate.

6. The method for manufacturing a glass substrate according to claim 1, wherein the prediction step and the adjustment step are performed in real time.

7. An apparatus for manufacturing a glass substrate, comprising:
a transport part for cooling a glass substrate transported by a plurality of rollers rotating at a predetermined speed;
a prediction part for predicting a crack defect rate of the glass substrate through a partial least squares regression analysis of a plurality of predictive factors related to crack defects of the glass substrate and rotational speed information of the respective rollers, in the transport process; and
a control part for controlling the rotation speed of each roller so that the crack defect rate of the glass substrate is lowered.
